(19) United States
(12) Patent Application Publication
(10) Pub. No.: US 2014/0304652 A1
(43) Pub. Date: Oct. 9, 2014

(54) ELECTRONIC DEVICE AND METHOD FOR UNLOCKING THE ELECTRONIC DEVICE

(71) Applicant: FIH (HONG KONG) LIMITED, Kowloon (HK)

(72) Inventor: CHI-SHENG LIU, New Taipei (TW)

(73) Assignee: FIH (HONG KONG) LIMITED, Kowloon (HK)

(21) Appl. No.: 14/244,909

(22) Filed: Apr. 4, 2014

(30) Foreign Application Priority Data
Apr. 9, 2013 (TW) 102112578

(51) Int. Cl. G06F 3/0488

(52) U.S. Cl. CPC G06F 3/0488
USPC 715/810

(57) ABSTRACT

In a method for unlocking an electronic device, one or more unlocking operations are defined, and one or more application groups are created. Each of the unlocking operations is associated with one or more of the application groups. According to the defined unlocking operations, a lock screen is generated and displayed on a display screen of the electronic device. When an unlocking operation is performed by a user, application groups associated with the unlocking operation are determined. The electronic device is unlocked according to the determined unlocking operation, and the determined application groups are displayed on the display screen.

### BACKGROUND

1. Technical Field

The embodiments of the present disclosure relate to access control mechanisms, and particularly to an electronic device and a method for unlocking the electronic device.

2. Description of Related Art

As more and more applications are installed in an electronic device, such as a mobile phone, to regulate accidental access to the applications, an unlock mechanism may be used. A user is required to perform an unlocking operation (e.g., swiping from a left edge of a screen of the electronic device) to unlock the electronic device. After the electronic device is unlocked, all the applications are accessible. However, sometimes different unlocking operations may be desired to gain access to different applications.

### BRIEF DESCRIPTION OF THE DRAWINGS

FIG. 1 is one embodiment of an electronic device.

FIG. 2 is a block diagram of one embodiment of function modules of an unlocking system of the electronic device in FIG. 1.

FIG. 3 is a flowchart of one embodiment of a method for unlocking the electronic device of FIG. 1.

FIG. 4 is one embodiment illustrating a first GUI element for a first unlocking operation and a second GUI element for a second unlocking operation.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

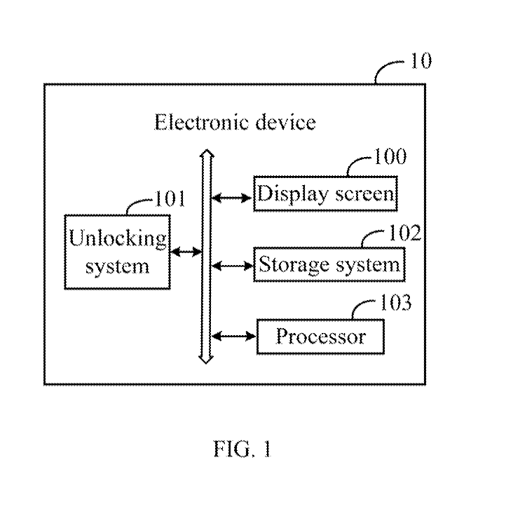

FIG. 1 is one embodiment of an electronic device 10. The electronic device 10 includes a display screen 100 and an unlocking system 101. The display screen 100 may be a touch screen, such as a resistive touch screen or a capacitive touch screen. When a user slides an object (e.g., a finger or stylus) on the touch screen, touch points are sensed. The unlocking system 101 allows a user to perform different unlocking operations to unlock the electronic device 10 and in response to the different unlocking operations, displays different applications accessible on the display screen 100. The electronic device 10 may be a mobile device, such as a mobile phone or a tablet computer. FIG. 1 is only one example of the electronic device 10, and other examples may comprise more or fewer components than those shown in the embodiment, or have a different configuration of the various components.

The electronic device 10 may further include a storage system 102 and at least one processor 103. The storage system 102 can be a dedicated memory, such as EPROM, a hard disk drive (HDD), or flash memory. In some embodiments, the storage system 102 can also be an external storage device, such as an external hard disk, a storage card, or other data storage medium. The at least one processor 103 can be a central processing unit (CPU), a microprocessor, or other suitable data processor chip that performs various functions of the electronic device 10.

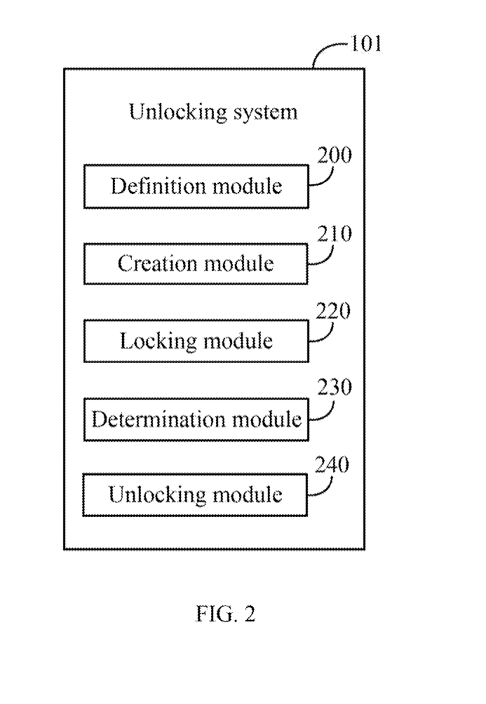

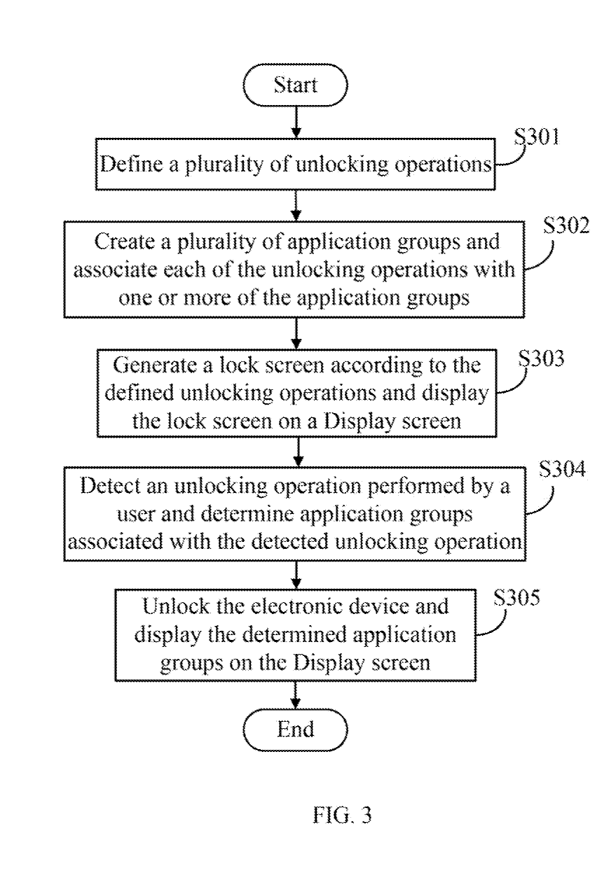

FIG. 2 is a block diagram of one embodiment of function modules of the unlocking system 101 shown in FIG. 1. The unlocking system 101 includes a definition module 200, a creation module 210, a locking module 220, a detection module 230, and an unlocking module 240. The modules 200-240 may comprise computerized codes in the form of one or more computer-readable programs that are stored in a non-transitory computer-readable medium, such as the storage system 102. The computerized codes include instructions that are executed by the at least one processor 103, to provide the aforementioned functions of the unlocking system 101. A detailed description of the functions of the modules 200-240 is given below in reference to FIG. 3.

FIG. 3 is a flowchart of one embodiment of a method for unlocking the electronic device 10 of FIG. 1. Depending on the embodiment, additional steps may be added, others removed, and the ordering of the steps may be changed.

In step S301, the definition module 200 defines a plurality of unlocking operations. Each unlocking operation can be performed by a user to unlock the electronic device 10. For example, the unlocking operations may be performed by entering a password, pressing a certain button of the electronic device 10, dragging an icon displayed on the display screen 100, or sliding an object (e.g., a finger or stylus) on the display screen 100. In one embodiment, for each unlocking operation, the locking module 220 may define a graphical user interface (GUI) element, such as a slider or an icon, with which the user performs the unlocking operation. The locking module 220 may further set visibility of GUI elements of the unlocking operations. If the GUI element of an unlocking operation is set as visible, the GUI element of the unlocking operation is displayed on the display screen 100 when the electronic device 10 is locked. Otherwise, if the GUI element of the unlocking operation is set as invisible, the GUI element of the unlocking operation is not displayed on the display screen 100 when the electronic device 10 is locked.

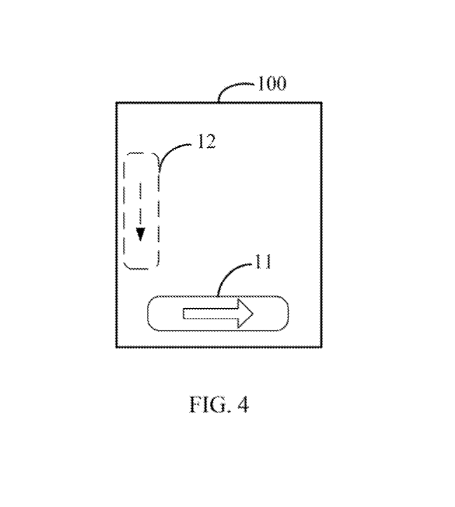

In one example with respect to FIG. 4, a first GUI element 11 for a first unlocking operation and a second GUI element 12 for a second unlocking operation are defined. The first unlocking operation is performed by sliding an object (e.g., a finger of the user) from left to right at a bottom of the display screen 100. The second unlocking operation is performed by sliding the object from up to down on a left side of the display screen 100. For the first unlocking operation and the second unlocking operation, coordinates of a departure touch point and coordinates of an arrival touch point on the display screen 100 may be defined. In this example, the first GUI element 11 is set as visible and the second GUI element 12 is set as invisible.

In step S302, the creation module 210 creates a plurality of application groups and associates each of the unlocking operations with one or more of the application groups. Each of the application groups includes one or more applications installed in the electronic device 10.

In one example, applications installed in the electronic devices are arranged into three application groups. A first application group includes basic applications such as phone, short message, calendar, and alarm. A second application group includes multimedia applications such as camera, music player, photos, and video player. A third application group includes network applications such as browser, online shopping, and online banking. In the embodiment, the creation module 210 associates the first application group and the second application group with the first unlocking operation, and associates the first application group and the third application group with the second unlocking operation.

In one embodiment, the creation module 210 sets visibility of application groups associated with the unlocking operations. If an application group associated with an unlocking operation is set as invisible, the application group is not displayed on the display screen 100 when the unlocking operation is performed by the user. For example, the first application group associated with the first unlocking operation is set as invisible. Therefore, if the user performs the first unlocking operation, the first application group is not displayed on the display screen 100.

In another embodiment, the creation module 210 sets visibility of applications included in an application group associated with the unlocking operations. For example, for the first unlocking operation, phone and short messages are set as invisible. For the second unlocking operation, phone and short messages are set as visible. Therefore, if the user performs the first unlocking operation, phone and short messages are not displayed on the display screen 100. If the user performs the second unlocking operation, phone and short messages are displayed on the display screen 100.

In step S303, the locking module 220 generates a lock screen according to the defined unlocking operations and displays the lock screen on the display screen 100. As such, the electronic device 10 is locked. For example, the locking module 220 displays the lock screen if the user does not operate the electronic device 10 for a predetermined time. As mentioned above, if a GUI element of an unlocking operation is set as visible, the GUI element of the unlocking operation is displayed on the lock screen. Otherwise, if the GUI element of an unlocking operation is set as invisible, the GUI element of the unlocking operation is not displayed on the lock screen.

In step S304, the detection module 230 detects an unlocking operation performed by the user and determines application groups associated with the detected unlocking operation. For example, if the user performs the first unlocking operation, the detection module 230 detects the first unlocking operation and determines the first application group and the second application group.

In step S305, the unlocking module 240 unlocks the electronic device 10 and displays the determined application groups on the display screen 100. Each application may be represented by an icon displayed on the display screen 100. For example, if the user executes the first unlocking operation, the unlocking module 240 displays the first application group and the second application group on the display screen 100. If the user executes the second unlocking operation, the unlocking module 240 displays the first application group and the third application group on the display screen 100. As mentioned above, if the application groups associated to the detected unlocking operation or the applications included in the application groups are set as invisible, the application group or the applications are not displayed on the display screen 100. In one embodiment, each application group is displayed in a page on the display screen 100. For example, if the user executes the first unlocking operation, the first application group is displayed in a first page and the second application group is displayed in a second page.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method for unlocking an electronic device being executed by a processor of the electronic device, the method comprising:
defining a plurality of unlocking operations;
creating a plurality of application groups and associating each of the unlocking operations with one or more of the application groups, each of the application groups comprising one or more applications installed in the electronic device;
generating a lock screen according to the defined unlocking operations, and displaying the lock screen on a display screen of the electronic device;
detecting an unlocking operation performed from the lock screen, and determining application groups associated with the detected unlocking operation; and
unlocking the electronic device according to the detected unlocking operation, and displaying the determined application groups on the display screen.

2. The method of claim 1, further comprising:
defining a graphical user interface (GUI) element for each unlocking operation.

3. The method of claim 2, wherein the GUI element of an unlocking operation is displayed on the display screen when the electronic device is locked and the GUI element of the unlocking operation is set as visible.

4. The method of claim 2, wherein the GUI element of the unlocking operation is not displayed on the display screen when the electronic device is locked and the GUI element of the unlocking operation is set as invisible.

5. The method of claim 1, further comprising:
setting visibility of application groups associated with the unlocking operations.

6. The method of claim 1, wherein each of the determining application groups is displayed in a page on the display screen.

7. An electronic device, comprising:
a display screen;
at least one processor; and
a storage system storing a computer-readable program comprising a plurality of instructions, which when executed by the at least one processor, causes the at least one processor to:
define a plurality of unlocking operations;
create a plurality of application groups and associate each of the unlocking operations with one or more of the application groups, each of the application groups comprising one or more applications installed in the electronic device;
generate a lock screen according to the defined unlocking operations, and display the lock screen on the display screen;
detect an unlocking operation performed from the lock screen, and determine application groups associated with the detected unlocking operation; and
unlock the electronic device according to the detected unlocking operation, and display the determined application groups on the display screen.

8. The electronic device of claim 7, wherein the computer-readable program further causes the at least one processor to define a graphical user interface (GUI) element for each unlocking operation.

9. The electronic device of claim 8, wherein the GUI element of an unlocking operation is displayed on the display screen when the electronic device is locked and the GUI element of the unlocking operation is set as visible.

10. The electronic device of claim 8, wherein the GUI element of an unlocking operation is not displayed on the display screen when the electronic device is locked and the GUI element of the unlocking operation is set as invisible.

11. The electronic device of claim 7, wherein the computer-readable program further causes the at least one processor to set visibility of application groups associated with the unlocking operations.

12. The electronic device of claim 7, wherein each of the determining application groups is displayed in a page on the display screen.

13. A non-transitory computer-readable storage medium storing a set of instructions, the set of instructions capable of being executed by a processor of an electronic device to implement a method for unlocking the electronic device, the method comprising:
defining a plurality of unlocking operations;
creating a plurality of application groups and associating each of the unlocking operations with one or more of the application groups, each of the application groups comprising one or more applications installed in the electronic device;
generating a lock screen according to the defined unlocking operations, and displaying the lock screen on a display screen of the electronic device;
detecting an unlocking operation performed from the lock screen, and determining application groups associated with the detected unlocking operation; and
unlocking the electronic device according to the detected unlocking operation, and displaying the determined application groups on the display screen.

14. The storage medium of claim 13, wherein the method further comprises:
defining a graphical user interface (GUI) element for each unlocking operation.

15. The storage medium of claim 14, wherein the GUI element of an unlocking operation is displayed on the display screen when the electronic device is locked and the GUI element of the unlocking operation is set as visible.

16. The storage medium of claim 14, wherein the GUI element of an unlocking operation is not displayed on the display screen when the electronic device is locked and the GUI element of the unlocking operation is set as invisible.

17. The storage medium of claim 13, wherein the method further comprises:
setting visibility of application groups associated with the unlocking operations.

18. The storage medium of claim 13, wherein each of the determining application groups is displayed in a page on the display screen.
